(19) United States
(12) Patent Application Publication
(10) Pub. No.: US 2009/0259937 A1
(43) Pub. Date: Oct. 15, 2009

(54) Brainstorming Tool in a 3D Virtual Environment

(76) Inventors: Steven L. Rohall, Winchester, MA (US); Li-Te Cheng, Malden, MA (US); Masato Ikura, Holmdel, NJ (US); Phuong B. Le, Bloomington, IL (US); John F. Patterson, Carlisle, MA (US)

Correspondence Address: HAMILTON, BROOK, SMITH & REYNOLDS, 530 VIRGINIA ROAD, PO BOX 9133, CONCORD, MA, 01742-9133, US

(21) Appl. No.: 12/101,401

(22) Filed: Apr. 11, 2008

(51) Int. Cl. G06F 3/14; G06F 15/16

(52) U.S. Cl. 715/706; 709/204; 715/757

(57) ABSTRACT

Computer-based group brainstorming system and method are disclosed. The invention system and method provide a certain area (e.g., a depicted room) as a brainstorming area in a virtual environment. A processor engine enables brainstorming sessions of multiple users in the certain area. For a given brainstorming session, the engine (i) indicates each user in the brainstorming session, and (ii) indicates communications (e.g., chat bubbles, votes, etc.) of each user in the brainstorming session. Color-coding of the users/avatars and communications may be used. Users may arrange indicia (e.g., indicators of project tasks) in the certain area in a manner that provides work flow or work assignments to users. Snapshots of the different states of a brainstorming session are enabled. User interaction with the artifacts of the brainstorming session remains active in the snapshots. Artifacts of a brainstorming session may later be reconstituted (reinstated) from a reloading of a snapshot into a subsequent session.

### RELATED APPLICATION(S)

Subject matter of the present invention has similar aspects to U.S. patent application Ser. No. 12/055,650, filed Mar. 26, 2008 for “Computer Method and Apparatus for Persisting Pieces of a Virtual World Group Conversation” and U.S. patent application Ser. No. 10/973,124, (published as US2006/0090137) for “Chat User Interface for Threaded Text Chat Systems,” both by assignee. These applications are herein incorporated, each in their entirety, by reference.

### BACKGROUND OF THE INVENTION

3D virtual worlds have traditionally been used for entertainment—socializing and gaming. As virtual worlds are adopted within the enterprise, there is a need to provide more business-oriented tools within the virtual world. In other words, the virtual worlds need to be contextualized around business processes. Current attempts to support business process within a virtual world have been limited to supporting information dissemination meeting—meetings where typically one or a few speakers present material to a large audience. These systems have focused on ways to present traditional meeting materials such as slides. Although they may provide a way for audience members to ask questions, the meetings supported are typically one-way meetings, with a presenter speaking to an audience. In many ways, they are virtual world analogs of traditional conference calls. As such, they are not very compelling and can actually detract from the meeting experience (e.g., by giving users an oblique, non-optimal viewing angle on the presented materials).

While these tools are not compelling for information-dissemination meetings, they are even less effective for brainstorming meetings. Brainstorming meetings are characterized by having a small number of participants (e.g., fewer than 12) with a goal of collaborating to produce an acceptable outcome. For example, a team could have a brainstorming meeting to discuss new features for a product, to design how to implement a new feature, or to analyze how to improve a business process. In the real world, these sorts of meetings are characterized by a free-form discussion among all participants, the use of whiteboards and other tangible artifacts (e.g., sticky notes), and the desire to capture the results of the meeting for archiving and subsequent review. None of the existing meeting tools in virtual worlds, such as Second Life, provide adequate support for these sorts of brainstorming meetings.

### SUMMARY OF THE INVENTION

The present invention addresses the problems of the prior are and provides a purpose-built brainstorming space (system, method and apparatus) within a virtual environment. The virtual environment may be a virtual world, 3D video, virtual gaming, enterprise business virtual meeting/conferencing, simulation and the like. Unlike the 3D mockups of traditional conference rooms, the invention “brainstorming room” provides features that specifically support the group collaborative process of brainstorming to solve a particular problem. At the same time, one embodiment of the invention system takes advantage of being a virtual world to allow user's avatars to manipulate meeting artifacts and to interact “face-to-face” in a way that is not possible with traditional conference calls.

In particular, though in a virtual world, the invention brainstorming room/system 1) enforces a common viewing angle that ensures that all users have a common perspective on the meeting, 2) provides an easy way to create and manipulate the equivalent of white board annotations and sticky notes, 3) provides a mechanism for bringing traditional meeting artifacts like slides and applications into the meeting rooms, and 4) gives users a way to save the current state of the brainstorm session/meeting for later manipulation and reflection.

In one embodiment, the invention system and method provide a certain area (e.g., a depicted room) as a brainstorming area in a virtual environment. A processor engine enables brainstorming sessions of multiple users in the certain area. For a given brainstorming session, the engine (i) indicates each user in the brainstorming session, and (ii) indicates communications (e.g., chat bubbles, votes, etc.) of each user in the brainstorming session. Various graphical indicators may be employed. Color-coding of the users/avatars and communications may be used. Users may arrange, position or otherwise locate/relocate indicia (e.g., indicators of project tasks) in the certain area in a manner that provides or otherwise indicates work flow or work assignments to users. Location may be with respect to respective areas designated per user. Snapshots of the different states of a brainstorming session are enabled. Snapshots of multiple brainstorming areas and sessions may be displayed, each snapshot presented in a billboard-style for example. User interaction with the artifacts (e.g., chat bubbles, calendars, slideshow slides, etc) of the brainstorming session remains active in the snapshots. Later reloading of a snapshot into a subsequent session, reconstitutes at least the chat bubbles in one embodiment.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic illustration of a screen view of a brainstorming room in one embodiment of the present invention.

FIG. 2 is a schematic illustration of the different floors of the brainstorming room of FIG. 1.

FIG. 3 is a schematic illustration of a screen view of a shared application launched in one floor/level of the brainstorming room of FIG. 1.

FIG. 4 is a schematic view of a computer network in which embodiments of the present invention operate.

FIG. 5 is a block diagram of a computer node in the network of FIG. 4.

FIG. 6 is a schematic illustration of a screen view having multiple room snapshots in one embodiment of the present invention.

FIG. 7 is a flow diagram of one embodiment of the present invention.

### DETAILED DESCRIPTION OF THE INVENTION

A description of example embodiments of the invention follows.

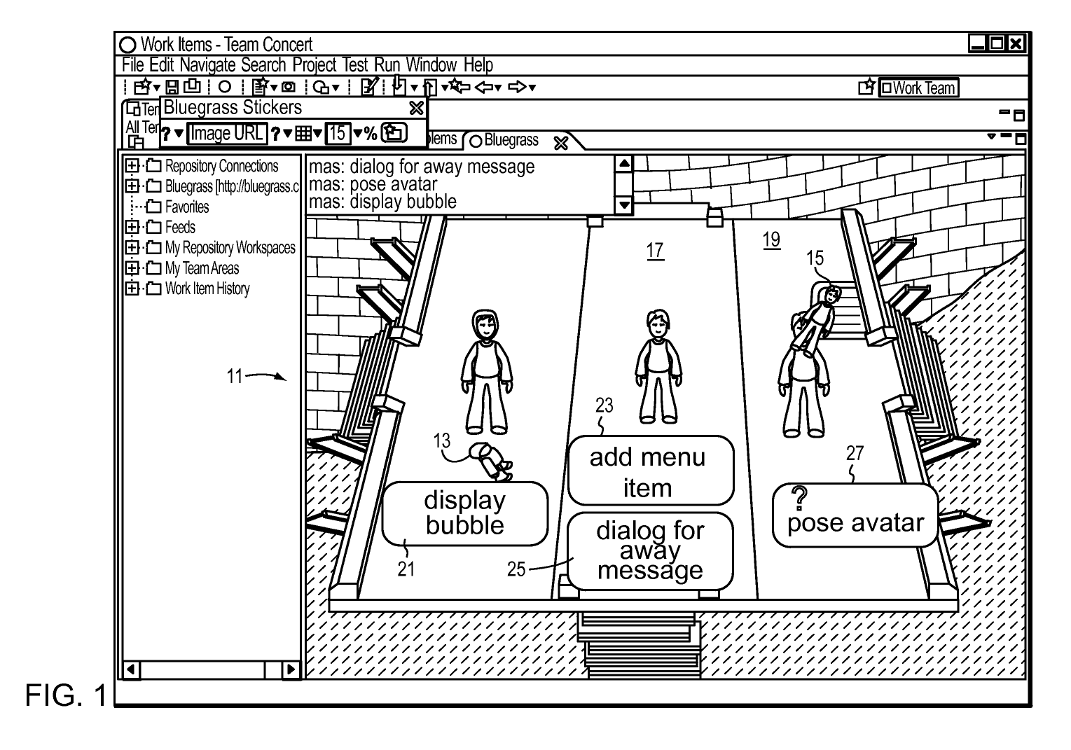

The basis of the present invention is the “brainstorming room” 11 illustrated in FIG. 1. In one embodiment, the brainstorming room 11 is depicted as having (i) side boundaries, (ii) a floor or similar work surface (plane) 19, and (iii) one or more exit areas (e.g. doors, steps or other). Other arrangements, floor geometries and depictions are suitable. Each user is represented by a respective avatar 13, 15 that maneuvers about in the room 11 under user control. Similar user control and interactive interface for maneuvering an avatar in common virtual worlds is employed in the invention brainstorming room 11.

When a user's avatar 13, 15 enters the room 11, his view, or camera angle, changes from an over-the-shoulder view, common in many virtual world systems, to a top-down view. Know techniques and virtual world camera angle technology are used to change user/avatar view in this way. This change in view (to top-down view) ensures that all users have an unobstructed view to the room 11. In addition, the top-down view ensures that all users have the same orientation and common perspective (viewing angle) of the room 11 so that “upper left”, for example, is the same for all users. This is extremely important when describing and manipulating brainstorming session artifacts.

As will be made clear below, brainstorming session artifacts include but are not limited to chat bubbles, calendar application effects, slide show application slides, shared applications and results (output) therefrom, and the like.

Brainstorming session artifacts in bubbles or other similar graphics are created simply by “talking”. That is, when an avatar 13 chats with others 15, the communicated words are represented in a chat bubble 17. Know chat and chat bubble technology are used. If no user interacts with the generated chat bubble 17, it floats away or otherwise disappears from the screen view. However, if any avatar 13, 15 grabs or otherwise interacts with the chat bubble 17, it becomes a persistent artifact within the brainstorming room 11.

This is accomplished in one embodiment by providing a respective programming object for each chat bubble 17. The programming object of a chat bubble 17 stores an attribute indicating state of the chat bubble 17. Upon user/avatar 13,15 interaction with the chat bubble 17, the invention system updates the state attribute to indicate persist=true. The corresponding programming object in turn serves as an object model effecting the persistent state of chat bubble 17 and the manipulation (move, drag, drop, etc.) of the chat bubble 17 in room 11 using common graphical user interface techniques. Further details are described in above noted U.S. patent application Ser. No. 12/055,650, herein incorporated by reference.

In FIG. 1, the yellow bubbles 21, 23, 25, 27 represent various tasks that need to be completed in a subject project or work unit. Although any user can grab and manipulate a chat bubble 17, 21, 23, 25, 27 in the room 11, the chat bubbles are color-coded by which avatar 13, 15 originally “said” the words and thus generated the chat bubble. In FIG. 1 the chat bubbles 21, 23, 25, 27 are yellow indicating that the avatar 15 with the yellow shirt spoke them. Once a chat bubble 17, 21, 23, 25, 27 has been interacted with by a user (and hence persisted), it can be manipulated in many ways. This is supported as mentioned above utilizing the corresponding object model.

In one embodiment, the persisted chat bubble can be used to describe a work flow, for example, or can be clustered by some attribute. FIG. 1 illustrates the chat bubbles 21, 23, 25, 27 clustered, distributed and/or otherwise arranged on the floor (work surface) 19 by who is assigned to do the work described on the chat bubbles. That is, chat bubble 21 is positioned to the left side of the floor 19 for the user of avatar 13 to work on displaying bubble implementation. The chat bubbles 23, 25 are effectively grouped together in the central third of the room floor 19 for another user/avatar to do the corresponding tasks of implementing “add menu item” and implementing “dialog for away message” in the subject project. Lastly, the “pose avatar” chat bubble 27 is positioned to the right hand side of the floor 19 for user/avatar 15 to work on (implement).

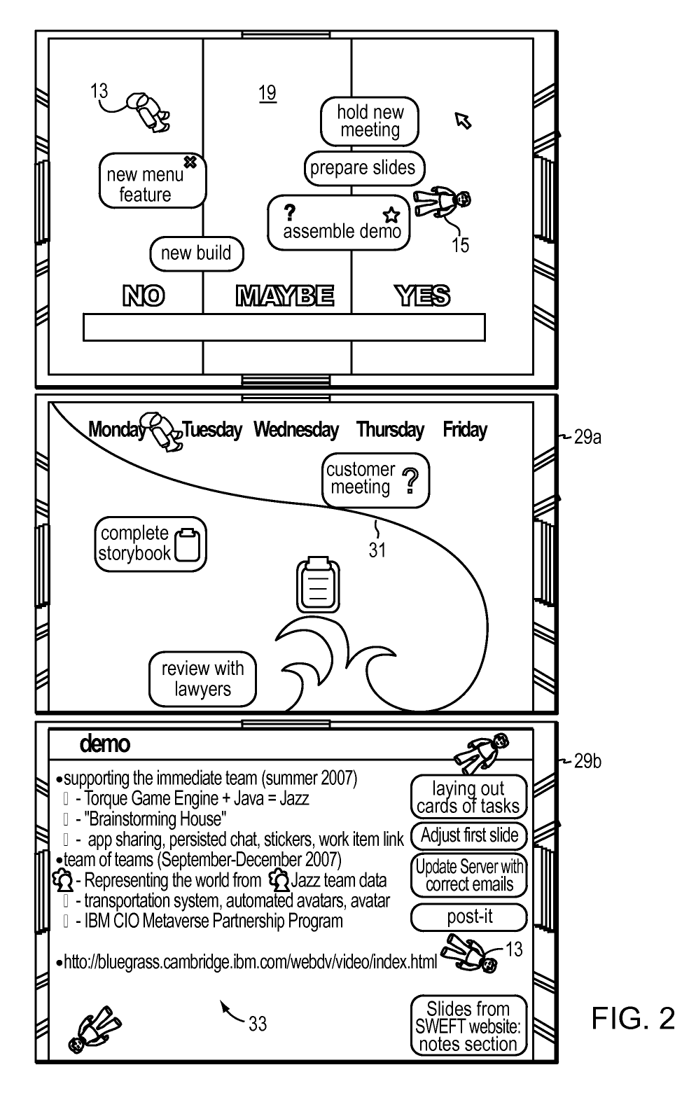

Another important brainstorming need is the ability to discuss things that may not have originated in the 3D virtual world. Users can change contents of the floor 19 in the invention brainstorming room 11 to suit their purpose. In a preferred embodiment, different floor levels (or other floors) hold the different contents. In the image in FIG. 1, for example, the (initial or base) floor 19 represents the users on the project. Other floors (or floor levels) 29 a, b, . . . n have calendars 31 from a calendar application or slides 33 from a slide presentation as illustrated in FIG. 2. In one embodiment, each floor or floor level is supported by a respective programming object having attributes for defining (linking or otherwise referencing) floor contents (e.g. calendar effects 31, slideshows/slides 33, shared applications 35, etc). The brainstorming room 11 is also supported by a respective programming object having attributes defining (or referencing) number of floors 19, 29, state of the room 11 and other aspects of the room 11.

Other technology such as state machines for defining state and contents of floors/levels 19, 29 and room 11 are suitable.

Avatars 12, 15 can point to and talk about the items 31, 33 on a floor 29 a, b, . . . n simply by walking to them. In this way, a user/avatar 13, 15 can “vote with their feet” in a very natural way. There is no need for a separate “voting tool” found in many traditional 2D, computer-based brainstorming tools. One implementation of this “vote with your feet” feature is disclosed and used in a system in Second Life by Drew Harry (web.media.mit.edu/˜harry/infospaces/), herein incorporated by reference. Other known techniques are suitable.

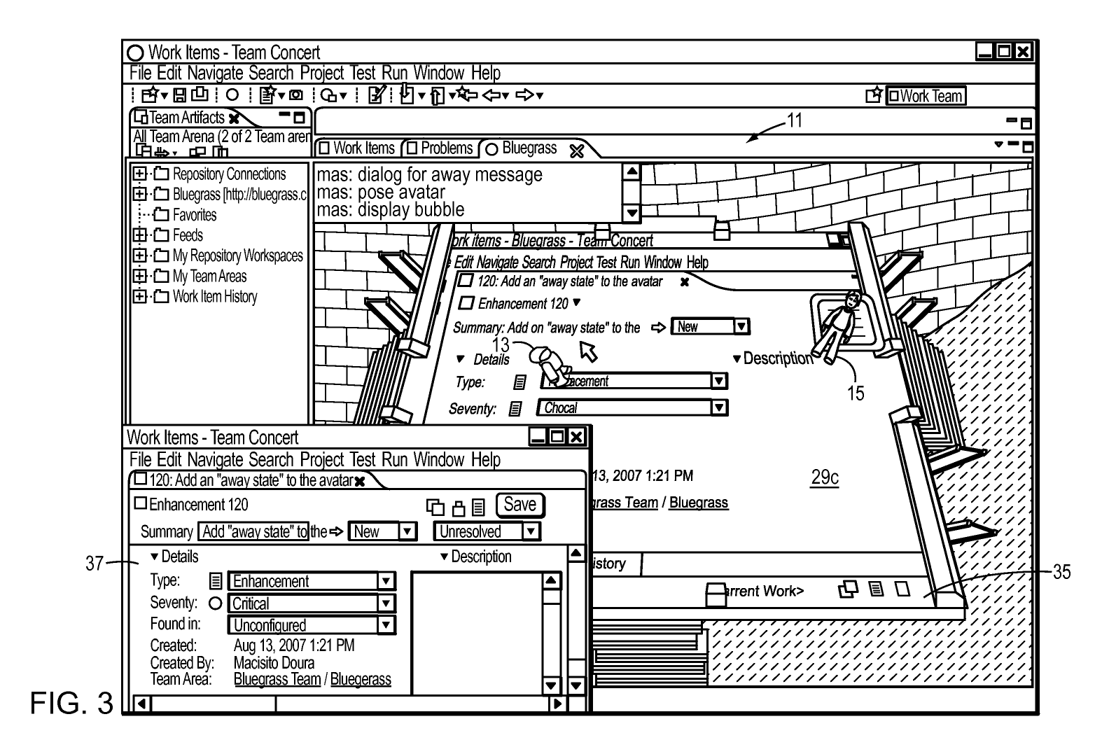

Another non-virtual world artifact that can be used in the brainstorming room 11 is a shared application 35. Using application program sharing, users can discuss software code or bug reports, for example. FIG. 3 depicts this. The invention system (brainstorming room) 11 enables users/avatars 13, 15 to bring (launch) shared application 35. System 11 displays the running application in a window 37 and/or a respective floor 29c using known windowing techniques, where the contents of the window 37 or floor 29c are software code, bug reports, and other effects or artifacts of the shared application 35, etc.

In one embodiment, one user (through his avatar 13) controls the shared application 35, but all avatars 13, 15 can interact with the application image on the floor 29c of the room 11 to discuss what is being presented.

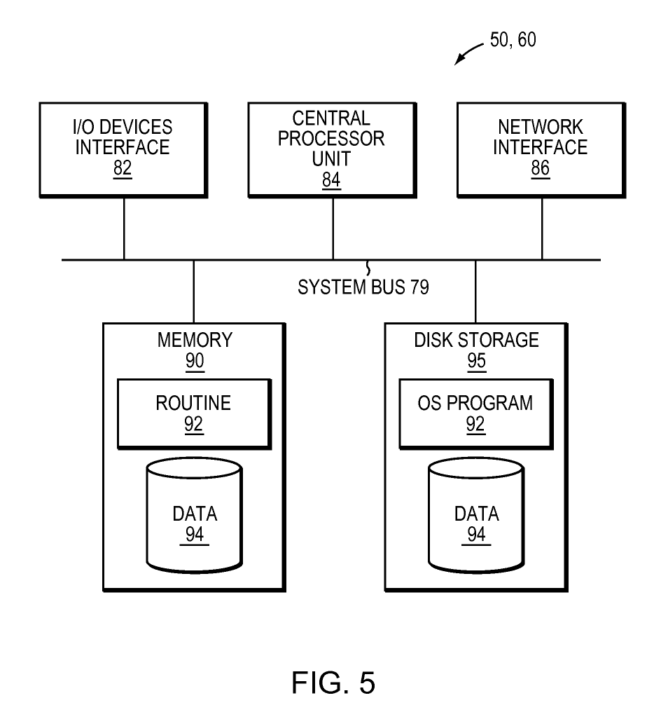

Finally, it is critical in brainstorming meetings that the state of the brainstorm session can be saved for later review. The invention system brainstorm room 11 enables a “snapshot” to be taken of the room 11 at any time. This snapshot, though, is not just a picture (captured image). For the snapshot, system 11 saves state and attribute values of each object representing a persisted chat bubble 17, 21, 23, 25, 27, of objects representing other meeting (brainstorming session) artifacts (e.g. calendars 31, slides 33 and shared applications 35) and of objects representing the floors 19, 29 and brainstorming room 11. System 11 may save this data for example in a database 94 or other system storage/memory (FIG. 5). When a snapshot is later “reloaded” into a working session of the virtual world, chat bubbles 17, 21, 23, 25, 27 are reconstituted (with corresponding object models) in the virtual world so that they can be manipulated again. This is accomplished using the stored data at 94 (FIG. 5), common data retrieval techniques, and state machine type technology and the like.

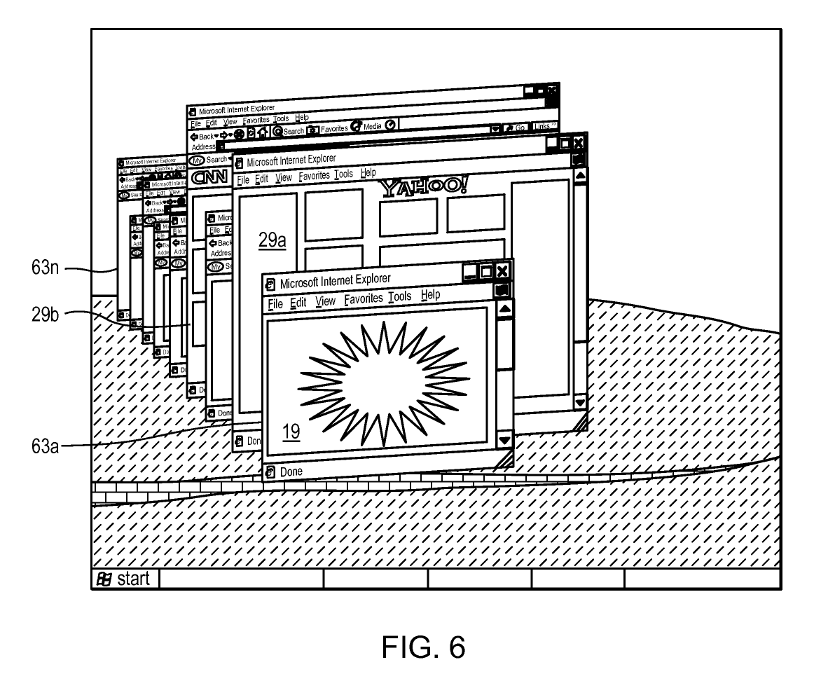

Turning to FIG. 6, this invention also encompasses a visualization for reviewing and manipulating multiple room snapshots 63a, b . . . n. As room snapshots 63 are taken, they can appear to be stood up like billboards, perhaps with some transparency (similar visually to Microsoft Vista's Flip3D (at www.microsoft.com/windows/products/windowsvista/features/details/flip3D.mspx) or Otaku's TopDesk (at www.mydigitallife.info/2007/01/13/alternative-to-use-windows-vista-flip-3 3d-feature-in-windows-xp-with-topdesk/). Similar or common other display techniques are used.

What differentiates this invention from the Flip3D and TopDesk is that the floors (and floor levels) 19, 29 are still “active” even though they are displayed in billboard fashion/format. That is, a user's avatar 13, 15 can walk through the floor billboards (snapshots 63a, b, . . . n) and continue to manipulate the artifacts, perhaps tying together items (chat bubbles 17, calendar 31, slides 33 . . . ) between floors 19, 29 or moving items from one floor to another. Note that the visualization shown in FIG. 6 is only one possible visualization of this multi-room snapshot feature. Others are suitable. Room 11 programming objects and floor 19, 29 programming objects (i.e. attributes, methods and operations thereof using common techniques) support the features illustrated by FIG. 6.

The teachings of all patents, published applications and references cited herein are incorporated by reference in their entirety.

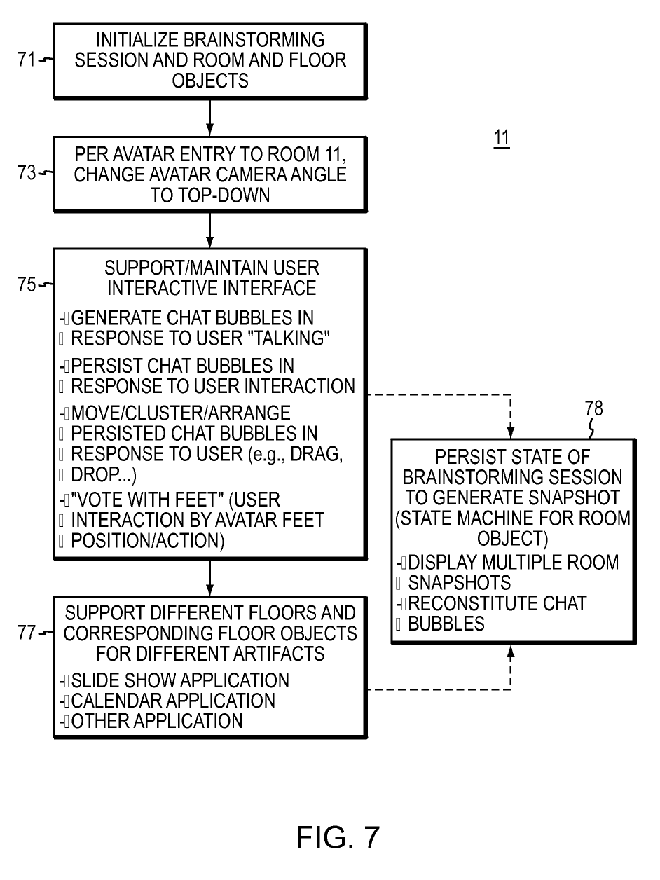

FIG. 7 is a flow diagram of one embodiment of the present invention. The processor or brainstorming room engine implementing invention room (each generally designated as 11) begins with an initialization step 71. In particular, step 71 initializes (a) a brainstorming session, (b) a programming object defining and detailing attributes of room 11 and (c) a respective programming object for each floor 19, 29 or floor level.

Engine 11 supports user avatar introduction and general display in the subject room 11 using common virtual environment/world technology.

Step 73 monitors avatar entry into invention room 11. Upon an avatar entering room 11, the processor/room engine 11 (step 73) changes the avatar's camera angle to top down. Effectively, step 73 normalizes users' views of the brainstorming room 11 by changing users' avatars' camera angle to a common orientation. Step 73 may color-code avatars entering room 11.

Next, at step 75, room engine 11 is responsive to user/avatar interaction. Step 75 employs common chat and other technology enabling users/avatars to interact with one another in room 11, including talking to one another and moving about the room 11. In response to a user/avatar talking, step 75 generates a chat bubble 17, on floor 19 preferably color coded to match or otherwise indicate the user/avatar speaker of the words forming the chat bubble contents. Step 75 updates attributes of the floor programming object to indicate the newly generated chat bubble 17.

Within a predefined time period, if another user/avatar interacts with or responds to the chat bubble 17 generated above, then step 75 persists the chat bubble 17. This is accomplished using techniques described above and disclosed in U.S. patent application Ser. No. 12/055,650 by assignee and herein incorporated by reference. Step 75 updates floor programming object reference of chat bubble 17 accordingly. Once persisted, chat bubbles 21, 23, 25, 27 are able to be moved around on room floor 19. Step 75 enables this feature using known “drag and drop” or similar technology. Step 75 enables users/avatars to arrange persisted chat bubbles 21, 23, 25, 27 in groupings, clusters or other patterns about floor 19. Step 75 updates the supporting floor object to indicate the arrangement of chat bubbles 21, 23, 25, 27, on floor 19 made by users/avatars in room 11.

In a preferred embodiment, user arrangement of chat bubbles 21, 23, 25, 27 on floor 19 indicates proposed work flow or project task assignment per user as described above in FIG. 1.

Further step 75 tracks foot steps (e.g. position/location) of avatars on floors 19, 29. As a function of closeness of avatar foot print to an item on a floor 19, 29, step 75 determines the corresponding user's interest in the item. In a preferred embodiment, step 75 employs known “vote with feet” technology here.

Step 75 continuously updates room programming object, floors programming objects and chat bubbles programming objects accordingly. This enables step 78 to persist the brainstorming session and produce snapshots 63 of room 11 on user command. Step 78 may employ a state machine or similar technology for detailing state of room 11, floors 19, 29 and contents thereof (chat bubbles 17, 21, 23, 25, 27, calendars 31, slides 33, shared applications 35) and content locations/positions per floor 19, 29.

In turn, step 77 supports the different floors 19, 29 and maintains respective floor programming objects. Specifically, in response to user/avatar action, step 77 updates floor programming objects, attributes detailing meeting (brainstorming session) artifacts, such as chat bubbles 17, 21, 23, 25, 27, calendars 31, slideshows 33 and shared applications 35, and floor locations/positions thereof (of each). Also in response to user command (interaction), step 77 supports importation and launching of slideshow applications, calendar applications and other applications, described in FIG. 3 above producing the room 11/brainstorming session artifacts.

In response to user command to make a snapshot 63 of the brainstorming room 11, step 78 effectively persists the state of the brainstorming session. This involves step 78 recording, from respective programming objects, state of the room 11, state of each floor 19, 29 and state and location of artifacts 17, 21, 23, 25, 27, 31, 33, 35 of each floor 19, 29. Step 78 employs data store 94 to hold this recorded data. Preferably, step 78 generates and displays one or more snapshots 63 of brainstorming room 11 in response to user command, each snapshot 63 being of a different state of the brainstorming session. Similarly snapshots of other brainstorming rooms may be obtained. In order to present multiple room 11 snapshots 63 (including snapshots of multiple rooms), step 78 provides the snapshots in a billboard or similar format as discussed above in FIG. 6 using known technology. While step 78 displays these bill boarded snapshots 63, the brainstorming session and room 11 remain active. Thus, users/avatars are able to interact within any snapshot 63 and the procedures of steps 73, 75, 77 are carried out accordingly.

In a preferred embodiment, brainstorming engine 11 enables subsequent review of a snapshot 63 in a later session in the virtual environment. Brainstorming engine 11 reloads the snapshot 63 and the accompanying recorded object data into the later session. In turn, step 78 reconstitutes at least the chat bubbles 17, 21, 23, 25, 27 of the reloaded snapshot 63. As a result, end users are able to (once again) manipulate and interact with these chat bubbles as discussed above.

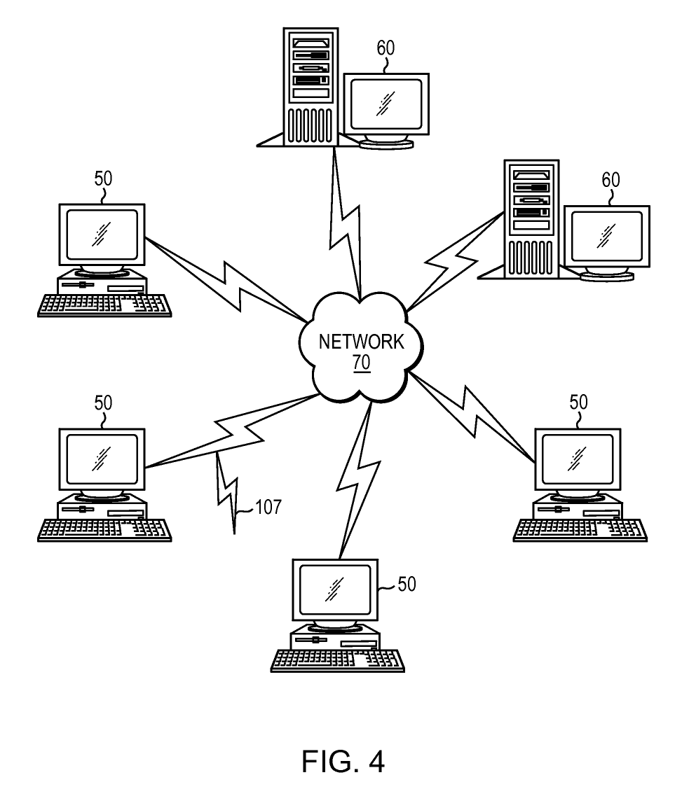

FIG. 4 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement an embodiment of the present invention (e.g., programming objects for room 11, floors 19, 29 and meeting artifacts 17, 21, 23, 25, 29, 31, 33, 35, and brainstorming room engine (processor) 11 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

While this invention has been particularly shown and described with references to example embodiments thereof, it will be understood by those skilled in the art that various changes in form and details may be made therein without departing from the scope of the invention encompassed by the appended claims.

For example, the computer configuration and architecture of FIGS. 4 and 5 are for purposes of illustration and not limitation. Other configurations, architectures and computer networks are suitable.

Also, the above description refers to chat bubbles 17, 21, 23, 25, 27. Other graphics, illustrations and the like may be used to indicate communications by user/avatar's. Various geometries, color schemes and other characteristics are contemplated.

Further this disclosure discusses one embodiment of the present invention in terms of a room in a virtual world. Other areas, planned space, structure, etc. are suitable. Also, the virtual environment may be any of a virtual world, video game, 3D video, simulation, remote/distributed conferencing and the like. The above described virtual world with brainstorming room 11 and floors 19, 29 are for purposes of non-limiting illustration of one embodiment. Other forms of the environment and room are contemplated.

What is claimed is:

1. A computer-based method of group brainstorming, comprising:
providing a certain area as a brainstorming area in a virtual environment; and
enabling brainstorming sessions of multiple users in the certain area, including for a given brainstorming session (i) indicating each user in the brainstorming session, and (ii) indicating communications of each user in the brainstorming session.

2. The method of claim 1 wherein each communication by a respective user is selectably persistent, the communication being persisted upon interaction of another user.

3. The method of claim 1 wherein the certain area is depicted as a room.

4. The method of claim 1 wherein indicating each user includes representing each user with a respective color coded avatar.

5. The method of claim 4 wherein indicating communications of each user includes illustrating communications of a user by respective graphical indicators having a color matching color of the user's respective avatar.

6. The method of claim 1 wherein indicating each user includes representing each user with a respective avatar; and
indicating communications of each user includes (a) representing votes of a user as a function of feet placement of the respective avatar, and (b) representing other communications of the user by respective graphical indicators.

7. The method of claim 1 wherein the communications of a user includes project tasks suggested by the user, each project task being indicated by a respective indicia.

8. The method of claim 7 further including in the given brainstorming session, indicating any of a work flow and user assignment of project tasks as a function of locational arrangement of the respective indicia in the certain area.

9. The method of claim 1 further including in the given brainstorming session, enabling a user to introduce any of:
calendar effects from a calendar application;
one or more slides from a slideshow application, and
a shared application
into the given brainstorming session.

10. The method of claim 9 wherein the certain area is illustrated with a different planar surface per user-introduced item.

11. The method of claim 1 further comprising enabling generation and display of one or more snapshots of the certain area representing corresponding states of the given brainstorming session.

12. The method of claim 11 wherein the snapshot is in a format displayable with respective snapshots of other brainstorming sessions, and the corresponding brainstorming session of each snapshot remaining active to user interaction through the snapshot when displayed.

13. The method of claim 11 wherein the corresponding state of the given brainstorming session in a snapshot is subsequently reconstituteable upon reloading of the snapshot into a later brainstorming session.

14. The method of claim 1 wherein the virtual environment is any of a virtual world, a 3D video, a gaming environment, a simulation and a conference.

15. Computer apparatus providing group brainstorming, comprising:
in a virtual environment, a certain area providing group brainstorming; and
a processor enabling brainstorming sessions of multiple users in the certain area, including for a given brainstorming session (i) indicating each user in the brainstorming session, and (ii) indicating communications of each user in the brainstorming session.

16. The computer apparatus of claim 15 wherein each communication by a respective user is selectably persistent, the communication being persisted upon interaction of another user.

17. The computer apparatus of claim 15 wherein the certain area is depicted as a room in a virtual world, and each user has a common viewing angle of the room.

18. The computer apparatus of claim 15 wherein indicating each user includes representing each user with a respective color coded avatar; and
wherein indicating communications of each user includes illustrating communications of a user by respective graphical indicators having a color matching color of the user's respective avatar.

19. The computer apparatus of claim 15 wherein the communications of a user includes project tasks suggested by the user, each project task being indicated by a respective indicia; and
the processor further enables users to indicate any of a work flow and user assignment of project tasks as a function of location of the respective indicia in the certain area.

20. The computer apparatus of claim 15 wherein the processor further enables a user to introduce any of:
calendar effects from a calendar application;
one or more slides from a slideshow application, and
a shared application
into the given brainstorming session.

21. The computer apparatus of claim 20 wherein the certain area displays a different planar surface per user-introduced item.

22. The computer apparatus of claim 15 wherein the processor further generates and displays one or more snapshots of the certain area representing corresponding states of the given brainstorming session, upon user command.

23. The computer apparatus of claim 22 wherein the processor displays each snapshot in a billboard-like format, the corresponding brainstorming session of each snapshot remaining active to user interaction, and the corresponding state of the given brainstorming session in a snapshot being subsequently reconstituteable upon reloading of the snapshot into a later brainstorming session.

24. The computer apparatus of claim 15 wherein the virtual environment is any of a virtual world, a 3D video, a gaming environment, a simulation and a conference.

25. A computer program product having a computer useable medium embodying a computer readable program which when executed by a computer causes:
providing a certain area as a brainstorming area in a virtual environment; and
enabling brainstorming sessions of multiple users in the certain area, including for a given brainstorming session (i) indicating each user in the brainstorming session, and (ii) indicating communications of each user in the brainstorming session.
